(19) United States
(12) Patent Application Publication
(10) Pub. No.: US 2023/0136628 A1
(43) Pub. Date: May 4, 2023

(54) ACOUSTIC SIGNALING DEVICE

(71) Applicant: AMIGO Spiel + Freizeit GmbH, Dietzenbach (DE)

(72) Inventor: Joachim ULBRICH, Rodermark (DE)

(21) Appl. No.: 17/964,505

(22) Filed: Oct. 12, 2022

(30) Foreign Application Priority Data
Oct. 28, 2021 (DE) 10 2021 128 121.0

(51) Int. Cl. G10K 1/072; G10K 1/26

(52) U.S. Cl. CPC G10K 1/072; G10K 1/26

(57) ABSTRACT

The present invention relates to an acoustic signaling device for generating an acoustic signal is provided, which comprises an oscillating body for generating the acoustic signal in an oscillating state, an excitation means for manual excitation of an oscillation of the oscillating body, and a holding means for holding the oscillating body and for bearing the excitation means, wherein the oscillating body comprises an opening through which the actuation element is guided, in order to bring about a strike of the excitation means on the oscillating body upon actuation of the actuation element. The acoustic signaling device is characterized by a cover, which consists of a resilient material and covers the oscillating body on a side opposite the excitation means, preferably completely.

### BACKGROUND OF THE INVENTION

The present invention relates to an acoustic signaling device for generating an acoustic signal, and a board game which comprises an acoustic signaling device of this type.

For example, some board games are based on the principle of determining a person who has solved a particular task first, or has answered a particular question fastest. For this purpose, it is expedient to perform the determination of the person who has solved the task or question the fastest using a manually actuatable acoustic signaling device, for example a table bell or the like. Thus, the actuation of the table bell results in the person actuating the table bell being clearly identified as the person who believes they are the first to have correctly solved the task or question.

A conventional table bell generally comprises a metal bell for generating an acoustic signal, and an actuating button arranged centrally on the top thereof. In the case of manual actuation of the actuating button, the bell is excited by an excitation means, for example a hammer or the like that strikes the inside of the bell.

In the relaxed atmosphere of a board game, it may be the case that the actuation of the table bell generally takes place not in a calm and purposeful manner, but rather, due to the competitive situation between the players, in a boisterous and imprecise manner.

In this case, the uncomfortable situation may arise, for the players of the board game, in which the hand of one player actuating the table bell first, is pushed in an uncomfortable manner, by a striking movement of another player (coming too late), onto the typically metal bell of the table bell, which can reduce the incentive to play and enjoyment of playing.

A conventional table bell is disclosed for example in DE 38 873 A or U.S. Pat. No. 264,226 A.

### SUMMARY OF THE INVENTION

The aim of the present invention is that of overcoming the disadvantages set out above and providing an acoustic signaling device, in particular a table bell, in the case of which the actuation of the signaling device is not perceived as uncomfortable for any of the game participants, even in hectic and boisterous game situations (in which inter alia the striking movement of the players also exerts a very high pressure on the signaling device).

This object is achieved by the acoustic signaling device comprising all the features herein, since the disadvantages set out above are overcome or reduced thereby. In this case, advantageous embodiments of the acoustic signaling device are set out in the description herein.

Thus, according to the present invention an acoustic signaling device for generating an acoustic signal is provided, which comprises an oscillating body for generating the acoustic signal in an oscillating state, an excitation means for manual excitation of an oscillation of the oscillating body, and a holding means for holding the oscillating body and for bearing the excitation means, wherein the oscillating body comprises an opening through which the actuation element is guided, in order to bring about a strike of the excitation means on the oscillating body upon actuation of the actuation element. The acoustic signaling device is characterized by a cover, which consists of a resilient material and covers the oscillating body on a side opposite the excitation means, preferably completely.

Accordingly, it is thus provided that, in the case of manual actuation of the acoustic signaling device, the hand of a player or user comes into contact only with the resilient material of the cover, and no direct contact with the oscillating body, which typically consists of metal, is possible. This preferably also applies in boisterous situations, as are typical for board games since the cover surrounds the oscillating body in a dome-like manner.

The presence of the cover consisting of resilient material prevents direct contact with the oscillating body which generally consists of hard metal, such that the disadvantageous uncomfortable feeling of direct contact with the oscillating body, under a high force effect, no longer occurs. The cover, consisting of a resilient material, acts as a damping layer, such that the gaming fun can be continued undisturbed even in boisterous or hectic gaming situations.

According to an optional development of the present invention, it can be provided for the oscillating body to have a dome-like or shield-like shape, and preferably for the opening to be arranged centrally in the dome-like or shield-like shape.

In this case, the dome-like or shield-like shape is brought into contact with the holding means, such that said holding means arches over the excitation means.

Furthermore, according to an advantageous development of the invention it can be provided for the cover to be designed in a hood-like manner, and/or for it to not touch the outside of the oscillating body remote from the excitation means, in an undeformed state.

The cover thus covers over the oscillating body such that, in the case of manual actuation of the signaling device, direct contact with the oscillating body is not possible. In this case, it is advantageous for the cover not to come into contact with the oscillating body, at least during a non-actuated state, but optimally also during actuation. According thereto, the cover is of such a design in which the oscillating body is covered over in a hood-like manner, and in the process, there is simultaneously a certain distance present between the oscillating body and the cover. The distance between the cover and the oscillating body ensures that the oscillations are not unnecessarily damped.

According to an advantageous modification of the present invention, it is provided for the cover to be produced from a deformable plastics material which, following deformation, springs back into its original shape. This results in the least possible impairment of the sound development, wherein, however, the desired positive effect of the cover is simultaneously achieved.

Furthermore, according to the present invention it can be provided for the actuation element arranged in the opening of the oscillating body to be movable back and forth along its longitudinal direction and, preferably in a rest position, to protrude to the outside of the oscillating body, on account of its interaction with the excitation means.

In this case, the actuation element can be designed in an approximately rod-like manner or in the form of a tappet, and in this case is arranged such that it extends through the opening in the oscillating body. In this case, it can be provided for the excitation means to be activated and an acoustic signal to be generated by contact with the oscillating body, by means of manual pushing in of the actuation element from an outside towards an inside of the oscillating body. In this case, this can be achieved by actuating a lever mechanism, in which a lever is pivoted about an axis, by means of the actuation element being pushed in, such that the end of the lever remote from the actuation element strikes against the inside of the oscillating body.

According to a further advantageous embodiment of the present invention it can be provided for the actuation element to be provided, at the end thereof remote from the oscillating body, with a contact surface which extends transversely to the longitudinal direction of the actuation element and which, when the signaling device is actuated as intended, preferably prevents direct contact of the cover with the oscillating body by way of pushing in the cover.

According to the present invention, the actuation of the acoustic signaling device takes place through the cover, wherein a preferred region for actuating the signaling device can be graphically shown or graphically defined on the side of the cover facing the user. This optical emphasis denotes a region, on the cover underside of which the actuation element is arranged, such that action on said portion of the cover leads to the desired acoustic signal. In order to now enlarge said region and simultaneously ensure that the acoustic signaling device generates the desired sound even in the case of action on the cover over a large surface area (for example by placing the entire palm of the hand on the signaling device), a contact surface extending transversely to the longitudinal direction of the actuation element is provided on the end of the actuation element protruding towards the cover, which contact surface increases the likelihood of successful actuation of the signaling device. Furthermore, however, said contact surface also ensures that, in the case of action on the cover over a large surface area, small or as few as possible surface regions of the cover come directly into direct contact with the oscillating body. Specifically, this would be associated with the undesired effect of the sound development being impeded, such that the desired generation of the acoustic signal does not occur in a satisfactory manner. Accordingly it is thus provided for the contact surface to act as a shield of the cover with respect to direct contact with the oscillating body, provided that the cover is pushed in at the region that is typically to be pushed in for actuating the acoustic signaling device. In this case, the diameter of the contact surface is smaller than the diameter of the oscillating body shape formed in a dome-like or hood-like manner.

Furthermore, in this connection it can be provided for the contact surface to have the basic shape of a circular flat disc, such that, in the state when pushed in, only a small contact surface for contact with the oscillating body shape, formed in a hood-like or dome-like manner, results. The contact with the oscillating body preferably occurs at or close to a node of oscillation of its fundamental oscillation, such that—if at all—only slight impairment results from the contact surface when the acoustic signal occurs.

Furthermore it can be provided according to the invention for a spring element, in particular a spiral spring, to be provided on the side of the contact surface remote from the oscillating body, which spring, upon actuation of the signaling device by the cover being pushed in, contributes to returning the cover to its original shape as quickly as possible. Accordingly, a spring element can thus be arranged between the contact surface and the underside of the cover, which spring element contributes to returning the cover to its original shape. Specifically, in some circumstances it may be the case that, in the case of an acoustic signaling device that is heavily used, the cover may no longer have sufficient stability to spring back to its original shape following actuation. However, in the case of a new acoustic signaling device too, the provision of a spring element is advantageous, since in this case the original shape is assumed more quickly.

According to a further optional development of the present invention it can be provided for the holding means to comprise a base plate on which a holder is arranged, which serves to receive the oscillating body, preferably by means of a snap-in connection. In this case, the holder of the base plate is typically designed such that it passes through the opening of the oscillating body and fixes the oscillating body in the region of the opening by means of a snap-in connection. In this case, the holder can be designed such that the actuation element is arranged in the in the interior of the holder, which is designed so as to be hollow.

Furthermore, the holder can also serve to support the excitation means, which can be implemented for example by a bent lever. In this case, when mounted on the holder the excitation means can be mounted so as to be rotatable about a pivot axis, such that, in conjunction with the actuation element, a pivot movement can be carried out which leads to striking against the inside of the oscillating body. According thereto, the pivot axis can be oriented so as to be lying, such that pushing down of a lever arm of the excitation means, brought about by actuation of the actuation element, leads to an upwards movement of a further lever arm which is arranged at an angle with respect thereto and which then comes into contact with the oscillating body. In this case, the contact surface of the excitation means can also consist of metal, in order to achieve excitation of the oscillating body which is as effective as possible.

According to an optional modification of the present invention, it can be provided for the base plate of the holding device to be circular and to have a peripheral ridge portion which is located on the edge and extends out of the plane of the base plate.

In this case, it can furthermore be provided for the maximum diameter of an oscillating body, designed in a shield-like or dome-like manner, to be smaller than the diameter of the base plate, designed in the manner of a circle, preferably wherein the maximum diameter of the oscillating body is more than 10%, preferably more than 20%, smaller than the diameter of the base plate.

According to a further modification of the present invention, it can be provided for the cover to end flush with the ridge portion, surrounds this peripherally on the outside, and/or is fastened thereon, preferably by using the resilient clamping force of the cover.

Furthermore it can be provided, according to the invention, for the cover to extend as far as the underside of the base plate remote from the holder, and to cover said underside in part or completely.

It can thus be provided for the cover to surround all the components of the acoustic signaling device.

The invention furthermore relates to a board game comprising an acoustic signaling device according to any of the variants discussed above.

### BRIEF DESCRIPTION OF THE DRAWING

Further features, details and advantages of the invention are evident from the following description of the FIGURE, in which:

FIG. 1: is an exploded view of an acoustic signaling device according to the invention.

### DESCRIPTION OF THE PREFERRED EMBODIMENT

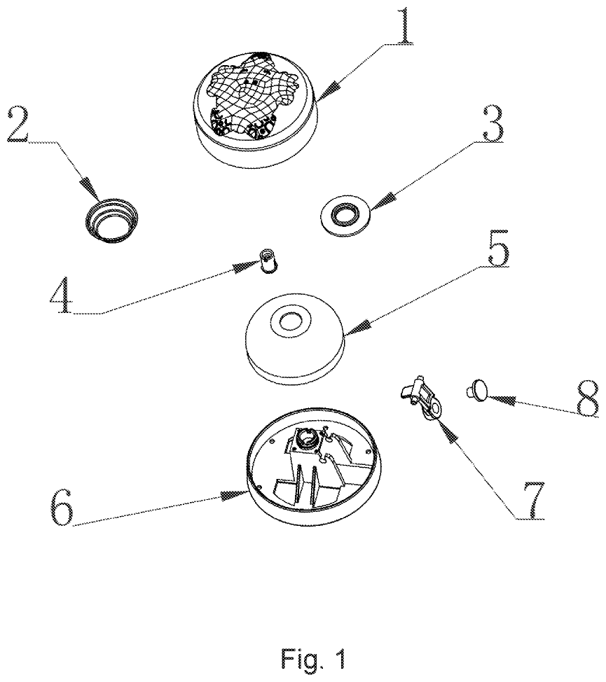

In the exploded view shown in FIG. 1, the structure of the acoustic signaling device according to the invention can be seen.

In this case, the holding device 6 extends proceeding from a base plate which comprises a ridge-like elevation on the circular outer periphery thereof. The receptacle for the excitation means 7, 8 is visible, which receptacle allows for a pivot movement in order for the excitation means 7, 8 to strike the oscillating body 5. A snap-in locking device is provided at the end of the holding device 6 remote from the base plate, which snap-in locking device serves to fix the opening of the oscillating body 5 such that the oscillating body 5 is held only in the region of the opening, which typically simultaneously corresponds to a node of oscillation of the fundamental oscillation of the oscillating body. In this case, the snap-in locking device is designed so as to be hollow, such that an actuation element 4, which is designed as a tappet, can interact with a region of the excitation means 7, 8. If the actuation element 4 is then pushed in, this thus leads to an upwards movement of the region of the excitation means 7, 8 which comes into contact with the oscillating body 5, such that this leads to the generation of an acoustic signal. In order to now enlarge the region of the actuation element 4, which leads to actuation of the acoustic signaling device, a discoid contact surface 3 is provided on the end of the actuation element 4 that protrudes outwards from the oscillating body 5, which contact surface furthermore is also associated with the positive effect that the cover, to be pushed in upon actuation of the signaling device, cannot come into direct contact with the region of the oscillating body 5 located below the contact surface 3.

A spring element 2 can be arranged on the side of the contact surface 3 remote from the oscillating body 5, which spring element serves to urge the cover 1 into its original shape. The spring element 2 may be a spiral spring and has a positive effect on the return of the cover 1 from its deformed state.

As is shown in the FIGURE, the spring element 2 can be a spiral spring, the diameter of which increases with distance from the oscillating body 5. As a result, the contact region for contact with the underside of the cover is enlarged, as a result of which the surface of the cover which acts on the actuation element is enlarged.

The cover 1 is formed of a resilient material and of course also covers the spring element 2 and the contact surface 3, in addition to the oscillating body 5. The cover 1 can be designed in a hood-like manner, wherein the edge region thereof facing the base plate or the holding device has a circular course and can have a diameter which is identical to that of the base plate or the upper ridge region of the base plate. Thus, the edge region of the cover can end flush with the ridge region or the base plate. Furthermore, however, the diameter can also be greater than that of the base plate or of the ridge region, such that the cover 1 peripherally surrounds the ridge region. In this case, the resiliency of the resilient material of the cover 1 can be used to bring about a clamped collection between the cover 1 and a base plate or the ridge region proceeding therefrom. Said clamped connection has the advantage that it simplifies the manufacture of the acoustic signaling device and does not require any further fastening means. Finally, the individual components of the signaling device can thus be connected to one another or snapped into one another, wherein in a final work step the cover 1 then only has to be pulled on.

Separate fastening, for example by an adhesive connection, is not essential, but can be provided.

1. Acoustic signaling device for generating an acoustic signal, comprising:
an oscillating body (5) for generating the acoustic signal in an oscillating state,
excitation means (7, 8) for manual excitation of an oscillation of the oscillating body (5),
holding means (6) for holding the oscillating body (5) and bearing the excitation means (7, 8), wherein
the oscillating body (5) comprises an opening through which an actuation element (4) is guided such that, upon actuation of the actuation element (4), bringing about striking of the excitation means (7, 8) on the oscillating body (5), and
a cover (1) of resilient material and covering the oscillating body (5) on a side opposite the excitation means (7, 8), preferably completely.

2. Signaling device according to claim 1, wherein the oscillating body (5) has a dome-like or shield-like shape, and the opening is preferably arranged centrally in the dome-like or shield-like shape.

3. Signaling device according to claim 1, wherein the cover (1) is designed in a hood-like manner and/or does not touch the outside of the oscillating body (5) that is remote from the excitation means (7, 8).

4. Signaling device according to claim 1, wherein the cover (1) is produced from a deformable plastics material which, following deformation, springs back into its original shape.

5. Signaling device according to claim 1, wherein the actuation element (4) arranged in the opening of the oscillating body (5) is movable back and forth along its longitudinal direction and, in a rest position, protrudes to the outside of the oscillating body (5), by interaction with the excitation means (7, 8).

6. Signaling device according to claim 1, wherein the actuation element (4) is provided, at the end thereof remote from the oscillating body (5), with a contact surface (3) which extends transversely to the longitudinal direction of the actuation element (4) and which, when the signaling device is actuated, prevents direct contact of the cover (1) with the oscillating body (5) by pushing in the cover (1).

7. Signaling device according to claim 6, wherein the contact surface (3) has the basic shape of a circular disc.

8. Signaling device according to claim 6, wherein a spring element (2), in particular a spiral spring, is provided on the side of the contact surface (3) remote from the oscillating body (5), which, upon actuation of the signaling device by the cover (1) being pushed in, contributes to returning the cover (1) to its original shape as quickly as possible.

9. Signaling device according to claim 1, wherein the holding means (6) comprises a base plate on which a holder is arranged, which serves to receive the oscillating body (5), preferably by a snap-in connection.

10. Signaling device according to claim 9, wherein the base plate of the holding device is circular and has a peripheral ridge portion which is located on the edge and extends out of the plane of the base plate.

11. Signaling device according to claim 10, wherein the cover (1) ends flush with the ridge portion, surrounds this peripherally on the outside, and/or is fastened thereon, preferably by using the resilient clamping force of the cover (1).

12. Signaling device according to claim 9, wherein the cover (1) extends as far as the underside of the base plate remote from the holder, and covers said underside in part or completely.

13. Board game, comprising an acoustic signaling device according to claim 1.

14. Signaling device according to claim 2, wherein the cover (1) is designed in a hood-like manner and/or does not touch the outside of the oscillating body (5) that is remote from the excitation means (7, 8).

15. Signaling device according to claim 14, wherein the cover (1) is produced from a deformable plastics material which, following deformation, springs back into its original shape.

16. Signaling device according to claim 3, wherein the cover (1) is produced from a deformable plastics material which, following deformation, springs back into its original shape.

17. Signaling device according to claim 2, wherein the cover (1) is produced from a deformable plastics material which, following deformation, springs back into its original shape.

18. Signaling device according to claim 15, wherein the actuation element (4) arranged in the opening of the oscillating body (5) is movable back and forth along its longitudinal direction and, in a rest position, protrudes to the outside of the oscillating body (5), by interaction with the excitation means (7, 8).

19. Signaling device according to claim 16, wherein the actuation element (4) arranged in the opening of the oscillating body (5) is movable back and forth along its longitudinal direction and, in a rest position, protrudes to the outside of the oscillating body (5), by interaction with the excitation means (7, 8).

20. Signaling device according to claim 17, wherein the actuation element (4) arranged in the opening of the oscillating body (5) is movable back and forth along its longitudinal direction and, in a rest position, protrudes to the outside of the oscillating body (5), by interaction with the excitation means (7, 8).
